(19) United States
(12) Patent Application Publication
(10) Pub. No.: US 2025/0191335 A1
(43) Pub. Date: Jun. 12, 2025

(54) DARK SHADING CORRECTION METHOD AND DEVICE FOR IMPLEMENTING THE SAME

(71) Applicant: SK hynix Inc., Icheon-si (KR)

(72) Inventors: Gon Ji LEE, Icheon-si (KR); Hyung Jun HAN, Icheon-si (KR)

(21) Appl. No.: 18/781,048

(22) Filed: Jul. 23, 2024

(30) Foreign Application Priority Data
Dec. 12, 2023 (KR) 10-2023-0179955

(51) Int. Cl. G06V 10/60; G06T 7/11

(52) U.S. Cl. CPC G06V 10/60; G06T 7/11

(57) ABSTRACT

A dark shading correction method and a device for implementing the same provide technology capable of performing correction for each portion of an image causing the dark shading phenomenon that may occur at various locations as a semiconductor chip increases in size. The dark shading correction method for processing images from an image sensing device is provided. The dark shading correction method includes dividing a dark image into a plurality of first division images, dividing each of the first division areas to be re-divided according to a predetermined standard into a plurality of second division areas, and calculating correction parameters of each of the division areas. As a result, the dark shading correction method and device perform individual dark shading correction for each portion of an image, resulting in formation of images with improved quality.

### CROSS-REFERENCE TO RELATED APPLICATION

This patent document claims the priority and benefits of Korean patent application No. 10-2023-0179955, filed on Dec. 12, 2023, the disclosure of which is incorporated herein by reference in its entirety as part of the disclosure of this patent document.

### TECHNICAL FIELD

The technology and embodiments disclosed in this patent document generally relate to a dark shading correction method of an imaging device, and a device for implementing the same.

### BACKGROUND

An image sensing device is a device for capturing at least one image using semiconductor characteristics that react to light incident thereon to produce an image. In recent times, with the increasing development of information technology (IT) industries and related technologies, the demand for high-quality and high-performance image sensing devices has been rapidly increasing in various electronic devices, for example, smartphones, digital cameras, etc.

Image sensing devices may be broadly classified into CCD (Charge Coupled Device)-based image sensing devices and CMOS (Complementary Metal Oxide Semiconductor)-based image sensing devices. Unlike in the past, CMOS image sensing devices have been intensively researched and rapidly come into widespread use.

Recently, as the demand for high-quality pixel image sensing devices has been increasing, the size of semiconductor chips used in image sensing devices has also been increasing. There is a problem in that the shading phenomenon depending on where pixels are located within a semiconductor chip becomes more severe as the influence of variables (e.g., voltage drop) depending on the chip location becomes greater, and shading correction techniques for correcting the shading phenomenon are required.

### SUMMARY

In accordance with an embodiment of the disclosed technology, a dark shading correction method for processing images from an image sensing device is provided. The dark shading correction method may include: dividing a dark image captured by the image sensing device with an array of image sensing pixels under a no-light conditions into a plurality of first areas; calculating a standard deviation for each of the plurality of first areas by using pixel values of at least one pixel included in each of the plurality of first areas; dividing a first area having a standard deviation greater than or equal to a preset reference standard deviation into a plurality of second areas; and calculating a correction parameter for each of correction target areas including a first area having a standard deviation less than the reference standard deviation and at least one of the plurality of second areas.

In some implementations, each of the plurality of second areas having an (m×n) matrix structure, wherein ‘m’ and ‘n’ are natural numbers and at least one of ‘m’ or ‘n’ is an integer equal to or greater than 2.

In some implementations, the dark shading correction method may further include: calculating a standard deviation for each of the plurality of second areas by using pixel values of at least one pixel included in each of the plurality of second areas; and dividing a second area having a standard deviation greater than or equal to the reference standard deviation into a plurality of third areas.

In some implementations, the dark shading correction method may further include calculating correction parameters for each of the plurality of third areas.

In some implementations, each of the plurality of third areas having an (m×n) matrix structure, wherein ‘m’ and ‘n’ are natural numbers, at least one of ‘m’ or ‘n’ is an integer equal to or greater than 2.

In some implementations, the correction parameter may be a value obtained by dividing a preset reference pixel value by an average of pixel values of pixels of each of the correction target areas.

In some implementations, the correction parameter may be obtained by dividing an average of pixel values of pixels of at least one first area located at a center of the dark image by an average of pixel values of pixels of each of the correction target areas.

In some implementations, the dark shading correction method may further include: assigning a correction grade to each of the correction target areas based on an average of pixel values of pixels of each of the correction target areas.

In some implementations, the correction parameter may be obtained by dividing an average of all pixel values of pixels included in the correction target areas having a median value of the correction grade by the average of pixel values of pixels of each of the correction target areas.

In accordance with another embodiment of the disclosed technology, an imaging device may include: an image sensing device including an array of pixels for converting incident light into pixel signals representing an image captured in the incident light, the captured image including a first correction target area having a first number of pixels, and a second correction target area having a second number of pixels, the second number being smaller than the first number; and a memory device storing a first correction parameter for correcting dark shading in the first correction target area due to noise present in the first number of pixels of the image sensing device without incident light thereto, and a second correction parameter for correcting dark shading in the second correction target area due to noise present in the second number of pixels of the image sensing device without incident light thereto.

In some implementations, the imaging device may further include: a third correction target area having a third number of the pixels, the third number being smaller than the second number, wherein the memory device further stores a third correction parameter for correcting dark shading in the third correction target area due to noise present in the third number of pixels of the image sensing device without incident light thereto.

In some implementations, the first correction target area may correspond to one of a plurality of first division areas obtained by equally dividing the image.

In some implementations, the second correction target area may correspond to one of a plurality of second division areas obtained by equally dividing one of the plurality of first division areas.

In some implementations, each of the plurality of second division areas may be arranged in areas of an (m×n) matrix structure, wherein ‘m’ and ‘n’ are natural numbers and at least one of ‘m’ and ‘n’ is an integer of 2 or more.

In some implementations, the first correction parameter and the second correction parameter may have different values from each other.

In accordance with another embodiment of the disclosed technology, a dark shading correction system for processing images captured by an image sensing device is provided. The dark shading correction system may include an image sensing device configured to generate at least one image under a no-light condition without incident light at the image sensing device; a dark image generator configured to generate a dark image based on the at least one image; a dark image division circuit configured to divide the dark image into a plurality of first areas, and to divide a first area having a standard deviation greater than or equal to a preset reference standard deviation into a plurality of second areas; an image division determiner configured to calculate a standard deviation for each of the plurality of first areas by using pixel values of at least one pixel included in the plurality of first areas, and to calculate a standard deviation for each of the plurality of second areas by using pixel values of at least one pixel included in the plurality of second areas; a correction parameter setting circuit configured to calculate a correction parameter for each of the correction target areas including first areas having a standard deviation less than the reference standard deviation and the plurality of second areas; and a memory device configured to store the correction target areas and correction parameters for each of the correction target areas.

In some implementations, wherein the dark image is divided into the plurality of first areas arranged in a (m×n) matrix structure wherein at least one of ‘m’ or ‘n’ is an integer equal to or greater than 2.

In some implementations, the dark image is divided into the plurality of first areas arranged in a (o×p) matrix structure wherein at least one of ‘o’ or ‘p’ is an integer equal to or greater than 2.

In some implementations, wherein the dark image division circuit is further configured to divide a second area having a standard deviation greater than or equal to the preset reference standard deviation into a plurality of third areas.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram showing an example of a dark shading correction system based on some implementations of the disclosed technology.

FIG. 2 is a flowchart illustrating an example of a dark shading correction method of the dark shading correction system shown in FIG. 1 based on some implementations of the disclosed technology.

FIG. 3 is a flowchart illustrating an example of a method for determining the correction target areas of FIG. 2 based on some implementations of the disclosed technology.

FIG. 4 is a diagram illustrating an example in which a dark image of FIG. 3 is divided into a plurality of first division areas based on some implementations of the disclosed technology.

FIG. 5 is a diagram illustrating an example of average values and standard deviations of pixel values of pixels included in each of the plurality of first division areas of FIG. 4 based on some implementations of the disclosed technology.

FIG. 6 is a diagram illustrating an example of a dark image in which a portion of the plurality of first division areas of FIG. 4 is re-divided to form a plurality of second division areas based on some implementations of the disclosed technology.

FIG. 7 is a diagram illustrating an example of average values and standard deviations of pixel values of pixels included in each of the plurality of second division areas of FIG. 6 based on some implementations of the disclosed technology.

FIG. 8 is a diagram illustrating an example of a dark image in which a portion of the plurality of second division areas of FIG. 6 is re-divided to form a plurality of third division areas based on some implementations of the disclosed technology.

FIG. 9 is a diagram illustrating an example of average values and standard deviations of pixel values of pixels included in each of the plurality of second division areas of FIG. 8 based on some implementations of the disclosed technology.

FIG. 10 is a diagram illustrating an example of the results of calculating correction parameters for each correction target area of the dark image of FIG. 8 according to a first embodiment of the disclosed technology.

FIG. 11 is a diagram illustrating an example of the results of calculating correction parameters for each correction target area of the dark image of FIG. 8 according to a second embodiment of the disclosed technology.

FIG. 12 is a flowchart illustrating an example of a method for calculating correction parameters of FIG. 2 according to a third embodiment of the disclosed technology.

FIG. 13 is a diagram illustrating an example of correction grade standards according to the third embodiment of FIG. 12.

FIG. 14 is a diagram illustrating an example of the results of calculating correction parameters for each correction target area of the dark image shown in FIG. 8 according to the third embodiment of the disclosed technology.

FIG. 15A is a diagram illustrating an example of a method for determining a median value of the correction grade shown in FIG. 12 according to the third embodiment.

FIG. 15B is a diagram illustrating an example of average pixel values of pixels of the target areas (to be corrected) each having a median value of the correction grade determined in FIG. 15B according to the third embodiment of the disclosed technology.

FIG. 15C is a diagram illustrating an example of the results of calculating correction parameters for each correction target area of the dark image shown in FIG. 8 according to the third embodiment of the disclosed technology.

### DETAILED DESCRIPTION

This patent document provides embodiments and examples of a dark shading correction method of an imaging device, and a device for implementing the same that may be used in configurations to substantially address one or more technical or engineering issues and to mitigate limitations or disadvantages encountered in some other devices. Some embodiments of the disclosed technology relate to technology capable of performing correction for each portion of an image causing the dark shading phenomenon that may occur at various locations as the size of a semiconductor chip increases. In recognition of the issues above, the dark shading correction method and the device for implementing the same based on some implementations of the disclosed technology may perform individual dark shading correction for each portion of an image, and may provide images with improved quality.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

In describing the components of the embodiments of the disclosed technology, various terms such as first, second, etc., may be used solely for the purpose of differentiating one component from another, but the essence, order and sequence of the components are not limited to these terms. Unless defined otherwise, all terms, including technical and scientific terms, used in the disclosed technology may have the same meaning as commonly understood by a person having ordinary skill in the art to which the disclosed technology pertains. It will be further understood that terms, such as those defined in commonly used dictionaries, may be interpreted as having a meaning that is consistent with their meaning in the context of the related art and the disclosed technology, and should not be interpreted in an idealized or overly formal sense unless expressly so defined herein.

Various embodiments of the disclosed technology relate to technology capable of performing correction for each portion of an image causing the dark shading phenomenon that may occur at various locations as the size of a semiconductor chip increases.

It is to be understood that both the foregoing general description and the following detailed description of the disclosed technology are illustrative and explanatory and are intended to provide further explanation of the disclosure as claimed.

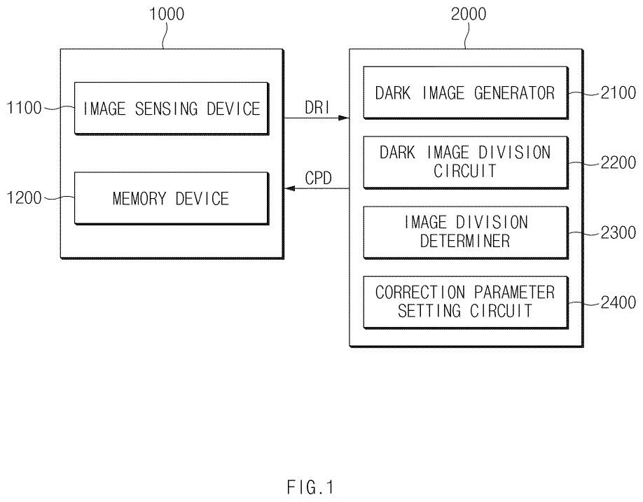

Hereinafter, embodiments of the disclosed technology will be described in detail with reference to FIGS. 1 to 15C.

FIG. 1 is a block diagram showing an example of a dark shading correction system 1 based on some implementations of the disclosed technology.

Referring to FIG. 1, the dark shading correction system 1 may include an imaging device 1000 and a dark shading correction device 2000.

The imaging device 1000 may include an image sensing device 1100 and a memory device 1200. The imaging device 1000 may be any one of electronic devices that include a photographing function, such as a camera, a smartphone, and the like.

In some implementations, the image sensing device 1100 may include a pixel array including a plurality of pixels that convert incident light received by the respective pixels into pixel signals that include image information carried by the incident light, pixel internal circuits within the pixels for processing the pixel signals, and logic circuits within the pixels to respectively convert the pixel signals into digital signals.

A pixel may include a microlens, an optical filter, and a photoelectric conversion element that converts light into electric charge in response to the received light for the pixel signal. The microlens may converge incident light from the outside onto the pixel. The optical filter may transmit light having a specific range of wavelengths among light beams included in the incident light. The photoelectric conversion element may generate photocharge in proportion to the amount of incident light having penetrated the optical filter and been received by the photoelectric conversion element.

The pixel internal circuit may include a floating diffusion region that accumulates photocharge generated by the photoelectric conversion element. A source follower transistor may output an electric signal to the logic circuit in response to the amount of photocharges accumulated in the floating diffusion region.

The logic circuit may include an analog-to-digital converter (ADC). The logic circuit may convert the electrical signal into a digital signal to generate pixel data.

The image sensing device 1100 may obtain a raw image by converting the electrical signal of each of the plurality of pixels into a digital signal. The raw image generated under a light-free condition where incident light is blocked from entering the pixels of the pixel array may be a dark raw image (DRI) that represents the background pattern formed by pixel signals without incident light.

The memory device 1200 may be a storage device that stores data. The memory device 1200 may store correction parameters (e.g., correction gain) used for image correction. The raw image or the dark raw image (DRI) may include the shading phenomenon by various factors (for example, location of pixel in the pixel array or degree of IR drop, etc.). The degree of the shading phenomenon may be different according to the location of the pixel. The shading phenomenon of the pixels may occur the difference of pixel value under the light-free condition between the pixels. The memory device 1200 may store a predominated data like the correction parameters to correct the difference of the pixel value. The memory device 1200 may be implemented as a non-volatile memory. For example, the memory device 1200 may include various non-volatile memory devices such as a read only memory (ROM) that can only read data, a one time programmable (OTP) memory that can write data only once, an erasable and programmable ROM (EPROM) memory that can erase and read the stored data, a NAND flash memory, a NOR flash memory, and the like. The memory device 1200 may be provided inside the image sensing device 1100 or may be installed separately from the image sensing device 1100. FIG. 1 illustrates an embodiment in which the memory device 1200 is separated from the image sensing device 1100.

The dark shading correction device 2000 may include a dark image generator 2100, a dark image division circuit 2200, an image division determiner 2300, and a correction parameter setting circuit 2400.

The dark image generator 2100 may receive a dark raw image (DRI). The dark image generator 2100 may receive at least one dark raw image (DRI) from the image sensing device 1110, and may generate a dark image using the received at least one dark raw image (DRI). Upon receiving the plurality of dark raw images (DRI) from the image sensing device 1110, the method for generating the dark images by the dark image generator 2100 may include calculating an average of pixel values of pixels corresponding to the same positions of the dark raw images (DRI). In some implementations, each pixel value of at least one pixel (referred to hereinafter as “at least one pixel value”) included in the dark raw image (DRI) may be an integer between 0 and 1023. The range of the at least one pixel value may be determined differently depending on the embodiments.

The dark image division circuit 2200 may divide the dark image into predetermined division areas. The dark image division circuit 2200 may divide (or segment) the dark image generated by the dark image generator 2100 into division images. When the image division determiner 2300 determines that additional division of the dark image is necessary, the dark image division circuit 2200 may further divide (or segment) the dark image into division areas. When the image division determiner 2300 determines that additional division of the dark image is unnecessary, the dark image division circuit 2200 may determine that image division has been completed.

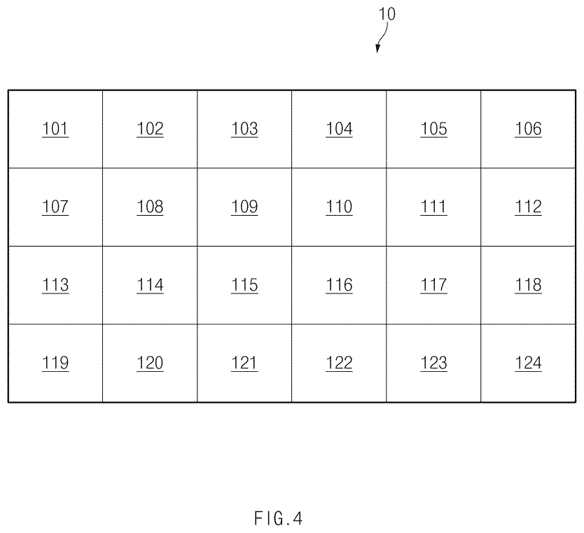

The image division determiner 2300 may determine whether the dark image division circuit 2200 needs to further divide the dark image. For example, when the dark image division circuit 2200 divides the dark image into a plurality of division areas, the image division determiner 2300 may determine whether re-division is required for each of the division areas. If the image division determiner 2300 determines the presence of an area to be re-divided according to predetermined standards, the dark image division circuit 2200 may further divide the area to be re-divided. The predetermined standards will hereinafter be described with reference to the drawings below FIG. 4.

The correction parameter setting circuit 2400 may set correction parameters for each of the correction target areas to be corrected. The correction target areas and data (CPD) for correction parameters for each of the correction target areas may be stored in the imaging device 1000 (e.g., the memory device 1200).

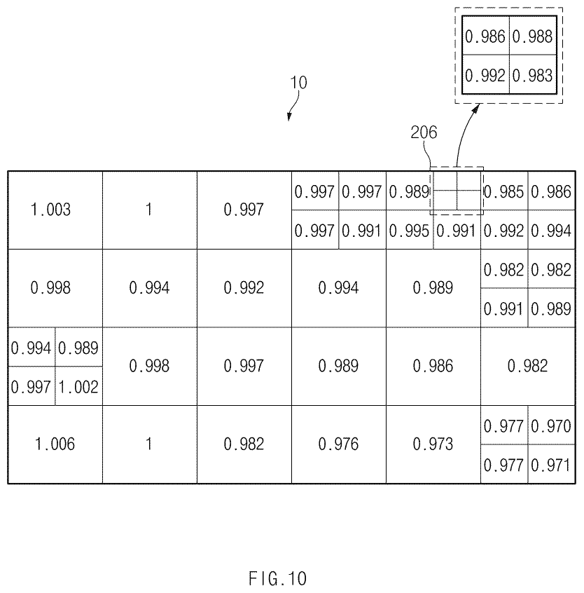

The operation of setting correction parameters will hereinafter be described with reference to the drawings below FIG. 10.

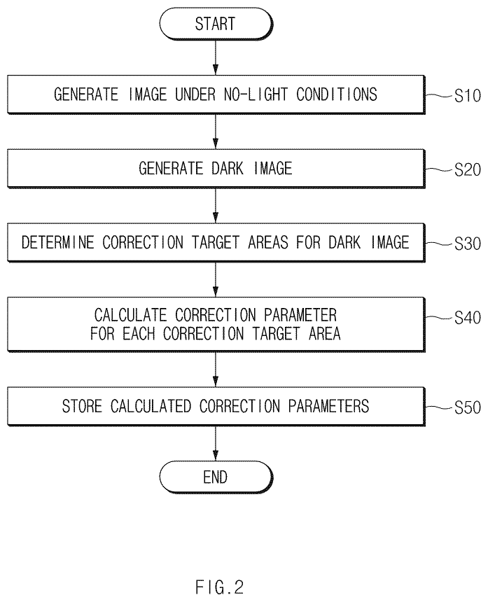

FIG. 2 is a flowchart illustrating an example of a dark shading correction method of the dark shading correction system shown in FIG. 1 based on some implementations of the disclosed technology.

Referring to FIGS. 1 and 2, the image sensing device 1100 may generate an image for a scene in a light-free state where no incident light is provided or allowed to reach the pixel array (no-light condition) (S10). According to one embodiment, the image sensing device 1100 may repeatedly generate images of the same scene multiple times (e.g., 20 times) under no-light conditions.

The dark image generator 2100 may generate a dark image using the image generated under the no-light condition (S20). When the image sensing device 1100 generates the image multiple times (e.g., 20 times), an average of pixel values of pixels corresponding to the same position of the generated images may be calculated to generate a dark image.

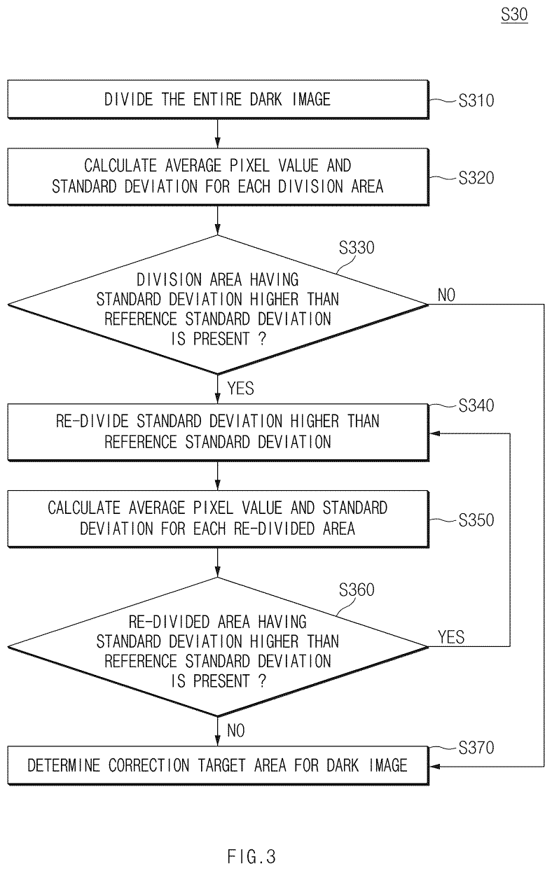

When the image division determiner 2300 determines that image division has been completed (when the image division determiner 2300 determines that there is no division area to be re-divided), the dark image division circuit 2200 may determine correction target areas of the dark image (S30). A detailed description of the method for determining the correction target areas of the dark image will be given later with reference to the drawings including FIG. 3.

Once the correction target areas of the dark image are determined, the correction parameter setting circuit 2400 may calculate a correction parameter for each division area included in the correction target areas (S40). A detailed description of the method for calculating the correction parameters will be given later with reference to the drawings including FIG. 10.

The memory device 1200 may store each division area included in the determined correction target areas and a correction parameter (CPD) calculated for each division area (S50).

FIG. 3 is a flowchart illustrating an example of the method (S30) for determining the correction target areas of FIG. 2 based on some implementations of the disclosed technology.

Operations S310 to S370 shown in FIG. 3 illustrate the operation S30 of FIG. 2 in more detail.

Referring to FIGS. 1 to 3, the dark image division circuit 2200 may divide the entire dark image generated by the dark image generator 2100 into a plurality of first division areas (S310). The plurality of first division areas may be divided into any shape. For example, the plurality of first division areas may have an (a×b) matrix structure. It is assumed that ‘a’ and ‘b’ are natural numbers and at least one of ‘a’ or ‘b’ is equal to or greater than 2. For example, ‘a’ is equal to or greater than 2, ‘b’ is equal to or greater than 2, or ‘a’ and ‘b’ are equal to or greater than 2. For example, the dark image division circuit 2200 may divide the dark image into images of a (3×4) matrix structure. In another example, the dark image division circuit 2200 may divide the dark image into images of a (4×6) matrix structure.

The image division determiner 2300 may calculate the average and standard deviation of pixel values of at least one pixel included in each of the plurality of first division areas (S320).

The image division determiner 2300 may determine whether the standard deviation of pixel values of pixels included in each of the plurality of first division areas is greater than or equal to a reference standard deviation (S330). In some implementations, the reference standard deviation may be, for example, 0.3. The reference standard deviation may be set differently depending on characteristics of the imaging device 1000 (e.g., a pixel size, a semiconductor chip size, etc.). In some implementations, the reference standard deviation may be preset and stored in the dark shading correction system.

If the standard deviation of pixel values of pixels included in each of the plurality of first division areas is less than the reference standard deviation (‘NO’ in S330), the dark image division circuit 2200 may determine the plurality of first division areas to be correction target areas (S370). The pixel value standard deviation may be a standard deviation of pixel values of at least one pixel included in each of the plurality of first division areas calculated in the operation S320. The average and the standard deviation of the pixel values of pixels included in each of the first, second, and third division areas will hereinafter be briefly described as “average pixel value” and “pixel value standard deviation”, respectively.

When a first division area having a pixel value standard deviation greater than or equal to a reference standard deviation among the plurality of first division areas is present (YES in operation S330), the dark image division circuit 2200 may divide the first division area having a pixel value standard deviation equal to or greater than the reference standard deviation into a plurality of second division areas (S340). The plurality of second division areas may be divided in a predetermined manner. In some implementations, each of the plurality of second division areas may have a (c×d) matrix structure. It is assumed that ‘c’ and ‘d’ are natural numbers and at least one of ‘c’ or ‘d’ is equal to or greater than 2. For example, ‘c’ is equal to or greater than 2, ‘d’ is equal to or greater than 2, or ‘c’ and ‘d’ are equal to or greater than 2. For example, each of the plurality of second division areas may have a (2×2) matrix structure. In another example, each of the plurality of second division areas may have a (3×3) matrix structure.

The image division determiner 2300 may calculate the average and standard deviation of pixel values of at least one pixel included in each of the plurality of second division areas (S350).

The image division determiner 2300 may determine whether the standard deviation of pixel values of pixels included in each of the plurality of second division areas is greater than or equal to the reference standard deviation (S360). The reference standard deviation of the operation S350 may be identical to the reference standard deviation of the operation S330.

When the pixel value standard deviation of each of the plurality of second division areas is less than the reference standard deviation (‘NO’ of S360), the dark image division circuit 2200 may determine at least one first division area having a pixel value standard deviation less than the reference standard deviation and the plurality of second division areas to be correction target areas (S370).

When at least one second division area having a pixel value standard deviation greater than or equal to a reference standard deviation among the plurality of second division areas is present (YES in operation S360), the dark image division circuit 2200 may divide at least one second division area having a pixel value standard deviation equal to or greater than the reference standard deviation into a plurality of third division areas (S340). The plurality of third division areas may be divided into any shape. In some implementations, each of the plurality of third division areas may have an (e×f) matrix structure. It is assumed that ‘e’ and ‘f’ are natural numbers and at least one of ‘e’ and ‘f’ is equal to or greater than 2. For example, ‘e’ is equal to or greater than 2, ‘f’ is equal to or greater than 2, or ‘e’ and ‘f’ are equal to or greater than 2. For example, each of the plurality of third division areas may have a (2×2) matrix structure. In another example, each of the plurality of third division areas may have a (3×3) matrix structure.

Thereafter, the operations S340 to S360 may be repeated in the same manner as described above for the plurality of second division areas. When the additional division operations S340 to S360 are completed, the dark image division circuit 2200 may determine the final state in which the dark image is divided after completing the additional division operations S340 to S360 to be the correction target areas (S370).

Hereinafter, the process (S30) of determining target areas to be used for dark image correction will be described with reference to the drawings below FIG. 4.

FIG. 4 is a diagram illustrating an example in which the dark image of FIG. 3 is divided into a plurality of first division areas based on some implementations of the disclosed technology.

Referring to FIGS. 1 to 4, the dark image 10 may be an example of an image generated through the operation S20 of FIG. 2. The dark image division circuit 2200 may divide the dark image into a plurality of first division areas. In some implementations, the plurality of first division areas may include first to twenty-fourth areas (101˜124). FIG. 4 is a diagram illustrating an example in which the dark image 10 is divided into first to twenty-fourth areas (101˜124) arranged in a (4×6) matrix structure.

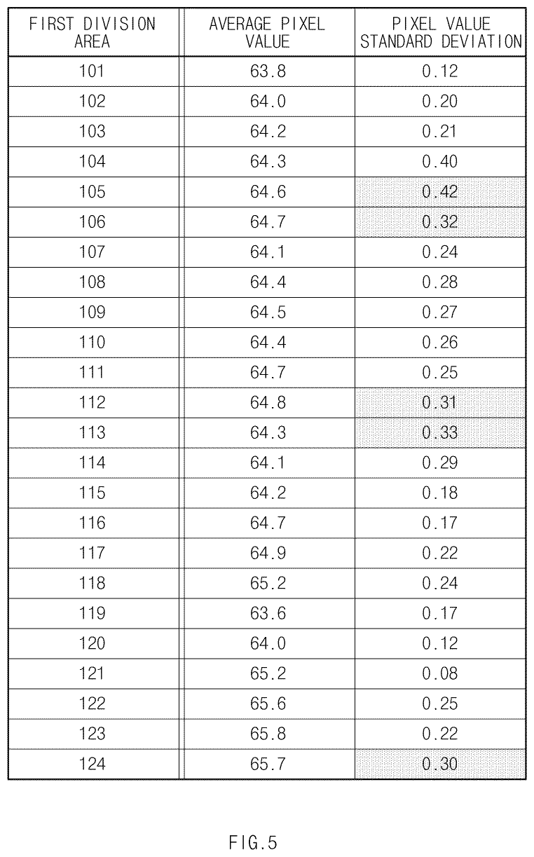

FIG. 5 is a diagram illustrating examples of the average pixel value and the standard deviation of pixel values of pixels included in each of the plurality of first division areas of FIG. 4.

In the following description depicted in the drawings including FIG. 5, numerical examples of the average pixel values, pixel value standard deviations, correction grades, and correction parameter values will be given as examples only for facilitating the understanding of the examples of the disclosed technology. The scope of the disclosed technology is not limited to such numerical examples.

Referring to FIGS. 1, 4, and 5, when the image division determiner 2300 calculates the average pixel value and the pixel value standard deviation of each of the first to twenty-fourth areas (101˜124), the result of calculation as shown in FIG. 5 can be obtained.

The image division determiner 2300 may determine whether an area having a pixel value standard deviation greater than or equal to the reference standard deviation from among the first to twenty-fourth areas (101˜124) is present. The reference standard deviation may be, for example, 0.3.

Referring to FIG. 5, the image division determiner 2300 may determine that a pixel value standard deviation of each of the twenty-fourth area 124, the fourth to sixth areas (104˜106), the twelfth and thirteenth areas (112, 113) is equal to or greater than the reference standard deviation of 0.3.

The range of pixel values, which can be allocated to the respective pixels included in the image sensing device 1100, may be, for example, an integer between 0 and 1023. As the amount of light incident upon the pixel increases, the pixel value of the corresponding pixel can be increased. In other words, the greater the amount of light incident upon a pixel, the higher the pixel value of the pixel.

An ideal pixel value of a pixel upon which light is not incident may be defined as an offset value, and the offset value may be a value determined experimentally. For example, the offset value may be 64. In one embodiment in which the offset value is 64, the range of pixel values (x) that can be allocated to each pixel included in the dark image 10 may be, for example, between 63 and 66 (i.e., 63≤x≤66). The range of pixel values of pixels of the dark image 10 may be different for various image sensing devices.

As the size of the semiconductor chip increases, a voltage drop phenomenon may occur depending on the position of the semiconductor chip. Even when a certain voltage is applied to the semiconductor chip, as the semiconductor chip is located farther away from the voltage source, the magnitude of a voltage to be actually applied to the semiconductor chip may become lower due to the voltage drop phenomenon. The pixel array included in the image sensing device 1100 may be disposed in the semiconductor chip.

When an image is generated under no-light conditions, the pixel value of each pixel of the pixel array is supposed to have an offset value of 64. With the voltage drop phenomenon, however, the pixel value of each pixel of the pixel array may have a value other than 64. As the semiconductor chip increases in size, the degree to which the pixel value deviates from 64 may become greater.

According to one embodiment in which 64 is set to an offset value of each pixel and the range of the pixel value is 0 to 1023, the result of calculating the averages and the standard deviations of pixel values of at least one pixel included in each of the first to twenty-fourth areas (101˜124) of the dark image 10 of FIG. 4 may appear as shown in the example of FIG. 5.

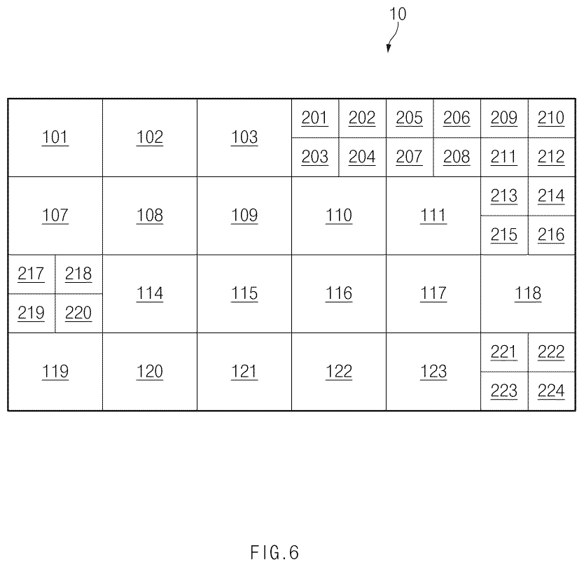

FIG. 6 is a diagram illustrating an example of a dark image in which a portion of the plurality of first division areas of FIG. 4 is re-divided to form a plurality of second division areas.

Referring to FIGS. 1, 4, and 6, the dark image division circuit 2200 may divide each of the fourth, fifth, sixth, twelfth, thirteenth, and twenty-fourth areas (104˜106, 112, 113, 124) into a plurality of second division areas. FIG. 6 illustrates an embodiment in which the dark image division circuit 2200 divides each of the fourth, fifth, sixth, twelfth, thirteenth, and twenty-fourth areas (104˜106, 112, 113, 124) of the dark image into the plurality of second division areas arranged in a (2×2) matrix structure for convenience of description, other implementations are also possible, and it should be noted that each area of the dark image may also be divided into other structures other than the (2×2) matrix structure. For example, the dark image division circuit 2200 may divide each of the fourth, fifth, sixth, twelfth, thirteenth, and twenty-fourth areas (104˜106, 112, 113, 124) into the second division areas arranged in a (3×3) matrix structure, or may divide each of the fourth, fifth, sixth, twelfth, thirteenth, and twenty-fourth areas (104˜106, 112, 113, 124) into division areas arranged in a non-matrix structure. The plurality of second division areas may include the 25th to 48th areas (201˜224). In more detail, the fourth area 104 may be divided into the 25th to 28th areas (201˜204). The fifth area 105 may be divided into the 29th to 32nd areas (205˜208). The sixth area 106 may be divided into the 33rd to 36th areas (209˜212). The twelfth area 112 may be divided into the 37th to 40th areas (213˜216). The 13th area 113 may be divided into the 41st to 44th areas (217˜220). The 24th area 124 may be divided into the 45th to 48th areas (221˜224).

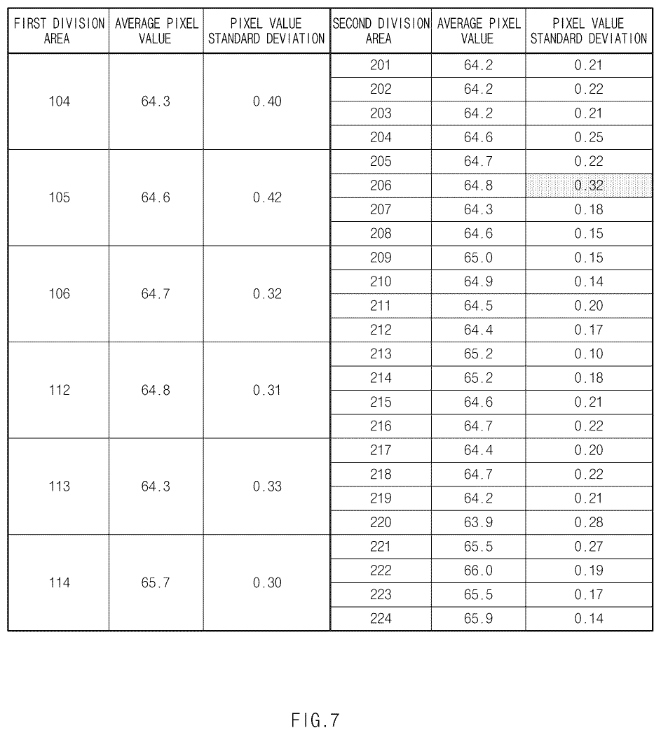

FIG. 7 is a diagram illustrating the average pixel values and the standard deviations of pixel values of each of the plurality of second division areas of FIG. 6.

Referring to FIGS. 1, 6, and 7, the image division determiner 2300 may calculate the average pixel value and the pixel value standard deviation of each of the 25th to 48th areas (201˜224) included in the plurality of second areas, and the calculation result may be the same as in FIG. 7.

The image division determiner 2300 may determine that the 30th area 206 from among the 25th to 48th areas (201˜224) has a pixel value standard deviation that is greater than or equal to the reference standard deviation of 0.3 (S360).

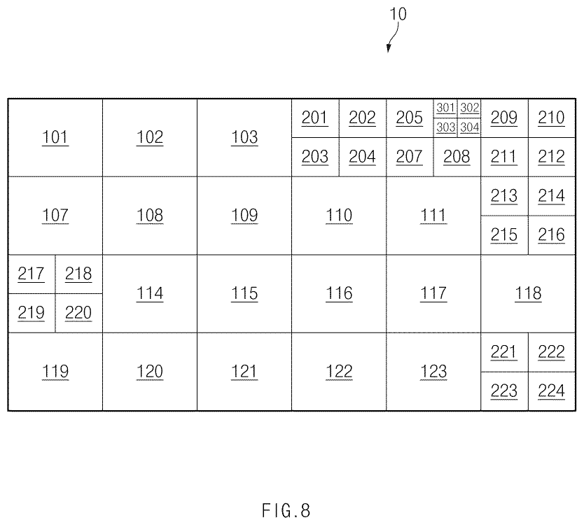

FIG. 8 is a diagram illustrating a dark image in which a portion of the plurality of second division areas of FIG. 6 is re-divided to form a plurality of third division areas.

Referring to FIGS. 1, 6, and 8, the dark image division circuit 2200 may divide the 30th area 206 into a plurality of third division areas. FIG. 8 exemplarily shows an embodiment in which the dark image division circuit 2200 divides each of the 30th areas 206 into the third division areas arranged in a (2×2) matrix structure for convenience of description, but the dark image division circuit 2200 may be divided into other structures other than the (2×2) matrix structure. For example, the dark image division circuit 2200 may divide each of the 30th areas 206 into the third division areas arranged in a (3×3) matrix structure, or may be divided into division areas of a non-matrix structure.

The plurality of third division areas may include the 49th to 52nd areas (301˜304). The 30th area 206 may be divided into the 49th to 52nd areas (301˜304).

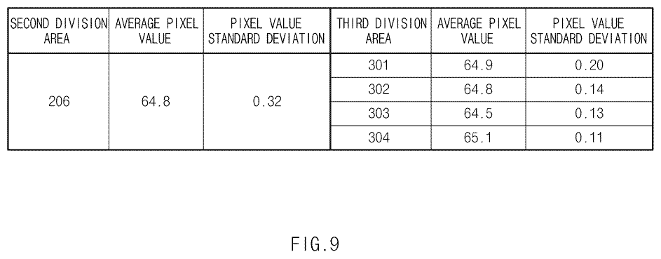

FIG. 9 is a diagram illustrating the average pixel values and the standard deviations of pixel values of pixels included in each of the plurality of third division areas of FIG. 8.

Referring to FIGS. 1, 8, and 9, the image division determiner 2300 may determine the average pixel value and the pixel value standard deviation of each of the 49th to 52nd areas (301˜304) included in the plurality of third areas. An exemplary result of calculating the average pixel values and the pixel value standard deviations of the 49th to 52nd areas (301˜304) by the image segmentation determiner 2300 is shown in FIG. 9.

The image division determiner 2300 may determine whether there is an area having a pixel value standard deviation greater than or equal to the reference standard deviation among the 49th to 52nd areas (301˜304), and may determine that there is no area having a pixel value standard deviation greater than or equal to the reference standard deviation among the 49th to 52nd areas (301˜304).

The dark image division circuit 2200 may determine “correction target areas” when there are no more areas each having a pixel value standard deviation greater than or equal to the reference standard deviation. The areas to be corrected (i.e., the correction target areas) may be areas shown in the dark image 10 of FIG. 8. More specifically, the areas to be corrected (i.e., the correction target areas) may include the first to third areas (101˜103), the seventh to eleventh areas (107˜111), the 14th to 23rd areas (114˜123), the 25th to 29th areas (201˜205), and the 31st to 52nd areas (207˜224, 301˜304).

After the correction target areas are determined, the correction parameter setting circuit 2400 may calculate correction parameters for each correction target area. The first to third embodiments illustrating example methods for calculating the correction parameters will hereinafter be described with reference to the drawings below FIG. 10.

FIG. 10 is a diagram illustrating the results of calculating correction parameters for each correction target area of the dark image of FIG. 8 according to the first embodiment.

Referring to FIGS. 1, 5, and 7 to 10, the method of calculating the correction parameters according to the first embodiment may be implemented as a method of using the offset value of the pixel described in FIG. 5. In the first embodiment, the offset value of the pixel may be set to 64, for example. The correction parameter may be set to a value obtained by dividing the offset value of 64 by an average pixel value of pixels of each division area included in the correction target area. The correction parameter may be, for example, a gain value to be used when the imaging device 1000 performs image correction in an image signal processing stage.

For example, in the case of the first area 101, the average pixel value may be 63.8 according to FIG. 5. Therefore, the correction parameter value of the first area 101 may be 1.003 obtained by dividing 64 by 63.8. Here, 1.003 may be a value rounded off to the fourth decimal place, and the correction parameter value will hereinafter be written as a value rounded off to the fourth decimal place. For example, in the case of the second area 102, the average pixel value may be 64.0 according to FIG. 5. Accordingly, the correction parameter value of the second area 102 may be 1 obtained by dividing 64 by 64. For example, in the case of the third area 103, the average pixel value may be 64.2 according to FIG. 5. Accordingly, the correction parameter value of the third area 103 may be 0.997 obtained by dividing 64 by 64.2.

The correction parameter may refer to a parameter for removing noise components due to dark shading that may occur in no-light conditions. The correction parameter may be a parameter that is multiplied by pixel data generated by the ADC of the image sensing device 1100. For example, 1.003, which is the correction parameter of the first area 101, may be multiplied by each pixel data of the pixels included in the first area 101 to perform correction for dark shading.

The correction parameter setting circuit 2400 may perform the same calculation process in the seventh to eleventh areas (107˜111), the 14th to 23rd areas (114˜123), the 25th to 29th areas (201˜205), and the 31st to 52nd areas (207˜224, 301˜304), and the results of performing the calculation process can be seen in FIG. 10. When the correction parameter is calculated according to the first embodiment, the result of calculating the correction parameter is that pixel values of pixels that have created the dark image are closer to the offset value, so that a dark image closer to black can be generated, and the effect of correcting the dark shading may increase.

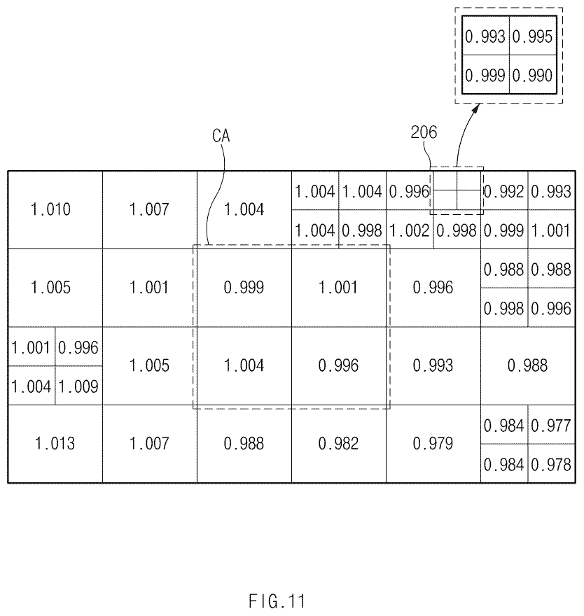

FIG. 11 is a diagram illustrating the results of calculating correction parameters for each correction target area of the dark image of FIG. 8 according to the second embodiment.

Referring to FIGS. 1, 5, 7 to 9, and 11, the method of calculating correction parameters according to the second embodiment may be a method of using an average of at least one division area located at the center of the division areas included in the correction target areas.

FIG. 11 illustrates an example in which the center area (CA) including the 9th, 10th, 15th, and 16th areas (109, 110, 115, 116) is shown as an example of at least one division area located at the center of the dark image. The average of the center area (CA) can be calculated by the method denoted by the following equation 1.

$$Average of Center Area ( CA ) = \frac{Sum of pixel values of all division areas included in CA}{Total number of pixels of division areas included in CA} \qquad [ Equation 1 ]$$

A result obtained by dividing the sum of pixel values of all pixels included in the ninth area 109, the tenth area 110, the fifteenth area 115, and the sixteenth area 116 by the total number of pixels included in the ninth, tenth, fifteenth, and sixteenth areas (109, 110, 115, 116) may be 64.45.

The correction parameter may be set to a value obtained by dividing the average of the center area (CA) by the average of pixel values of pixels of each of the division areas included in the correction target area. The correction parameter may be, for example, a gain value used when the imaging device 1000 performs image correction in the image signal processing stage.

For example, in the case of the first area 101, the average pixel value may be 63.8 according to FIG. 5. Accordingly, the correction parameter value of the first area 101 may be 1.010 obtained by dividing 64.45 by 63.8. For example, in the case of the second area 102, the average pixel value may be 64.0 according to FIG. 5. Accordingly, the correction parameter value of the second area 102 may be 1.007 obtained by dividing 64.45 by 64. For example, in the case of the third area 103, the average pixel value may be 64.2 according to FIG. 5. Accordingly, the correction parameter value of the third area 103 may be 1.004 obtained by dividing 64.45 by 64.2.

The correction parameter setting circuit 2400 may perform the same calculation process in the seventh to eleventh areas (107˜111), the 14th to 23rd areas (114˜123), the 25th to 29th areas (201˜205), and the 31st to 52nd areas (207˜224, 301˜304), and the results of performing the calculation process can be seen in FIG. 11. When the correction parameter is calculated according to the second embodiment, this correction parameter is calculated based on the average of pixel values of pixels located at the center of the pixel array, so that only some pixels located close to the edge area of the dark image can be intensively corrected.

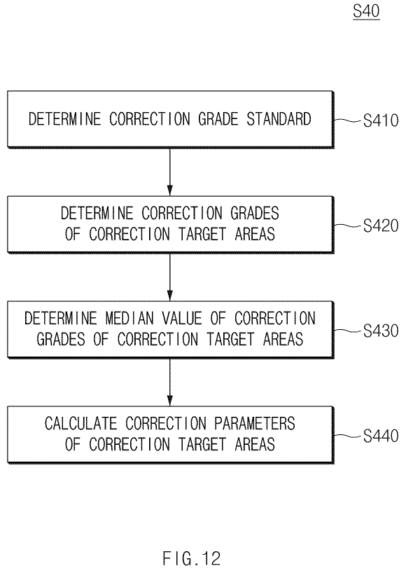

FIG. 12 is a flowchart illustrating an example of the method for calculating correction parameters of FIG. 2 according to a third embodiment of the disclosed technology.

Referring to FIGS. 1, 12, and 14, operations S410 to S440 are operations that show in more detail an example of the operation S40 of calculating correction parameters for each of the correction target areas of FIG. 2.

The correction parameter setting circuit 2400 may set a correction grade standard by considering the maximum and minimum values of the average pixel values of pixels of each division area included in the correction target areas (S410).

More specifically, as an example, the correction parameter setting circuit 2400 may acquire a calculation value that is obtained by dividing a difference between the maximum value and the minimum value by the number of correction grades, may round off the calculation value to two decimal places, and may thus determine a correction grade section to be corrected.

The correction parameter setting circuit 2400 may assign a correction grade for each correction target area according to the determined correction grade section (S420).

The correction parameter setting circuit 2400 may determine the median value of the correction grade for each of the correction target areas (S430).

The correction parameter setting circuit 2400 may calculate a correction parameter for each of the correction target areas using the average of pixel values of all pixels included in the correction target areas having the median value (S440).

A value that is obtained by dividing the average of pixel values of all pixels of the correction target areas having the median value by the average of pixel values of pixels of the correction target areas may be the correction parameter of the corresponding correction area.

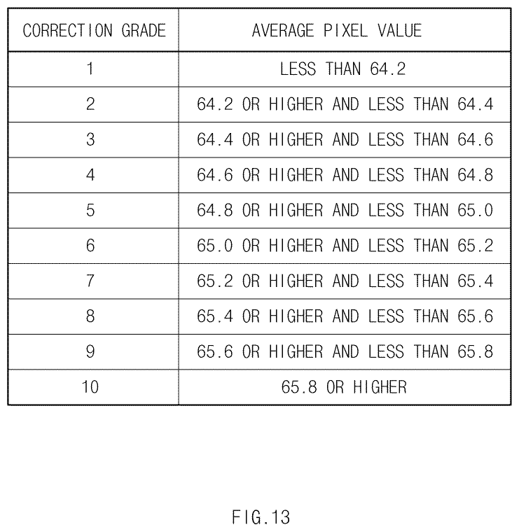

FIG. 13 is a diagram showing correction grade standards determined according to the third embodiment of FIG. 12.

According to FIGS. 5, 7, and 9, the minimum value of the average pixel values among the division areas included in the correction target areas may be 63.8, which is the average pixel value of the first area 101. In addition, the maximum value of the average pixel values among the division areas included in the correction target area may be 66.0, which is the average pixel value of the 46th area (222). The difference between the maximum value and the minimum value can be calculated as 2.2. For example, the correction grade may be divided into 10 grades. As another example, the correction grade may be divided into eight grades. The correction grade standard may be set to have a constant section length. The section length for each correction grade may be determined by considering the difference between the maximum value and the minimum value.

Referring to FIGS. 1, 12, and 13, in one embodiment where the correction grade is divided into 10 grades, the correction parameter setting circuit 2400 may determine the length of a section for each correction grade to be, as an example value, 0.2 by considering that a difference between the maximum value and the minimum value may be 2.2. Here, 0.2 may be obtained by rounding off 0.22 (=2.2/10) to two decimal places. In FIG. 13, the correction grade standards are shown when the section length for each correction grade is set to 0.2.

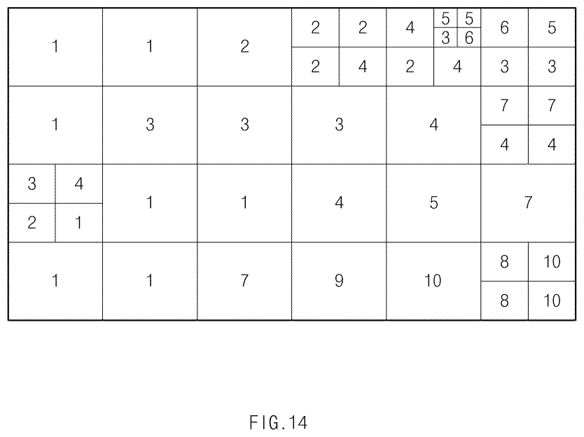

FIG. 14 is a diagram illustrating the results of calculating correction parameters for each correction target area of the dark image of FIG. 8 according to the third embodiment.

Referring to FIGS. 1, 5, 7 to 9, and 12 to 14, the average of the first area 101 is 63.8, which is less than 64.2, so that the first area 101 may be assigned ‘Level 1’. For example, since the average of the second area 102 is 64.0, which is less than 64.2, the second area 102 may be assigned ‘Level 1’. For example, the average of the third area 103 is 64.2, which is between 64.2 and 64.4, so that the third area 103 may be assigned ‘Level 2’.

The correction parameter setting circuit 2400 may perform the same calculation process in the seventh to eleventh areas (107˜111), the 14th to 23rd areas (114˜123), the 25th to 29th areas (201˜205), and the 31st to 52nd areas (207˜224, 301˜304), and the results of performing the calculation process can be seen in FIG. 14.

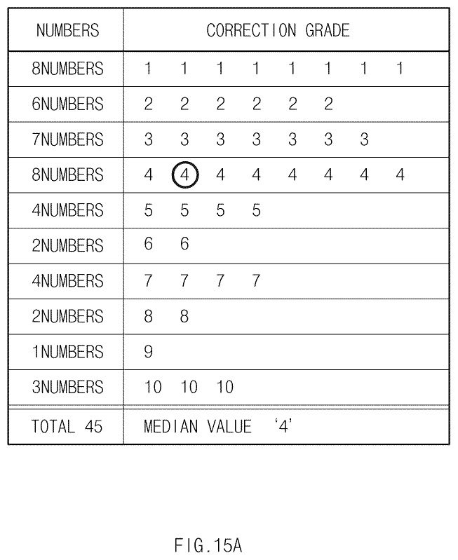

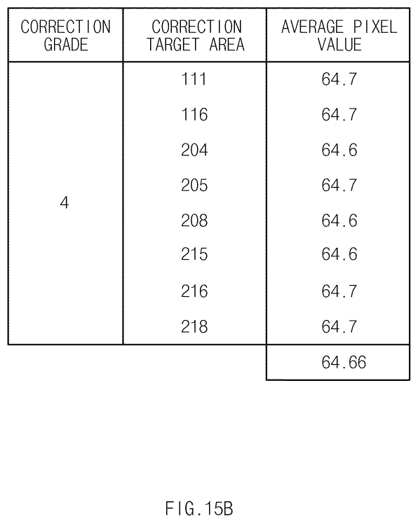

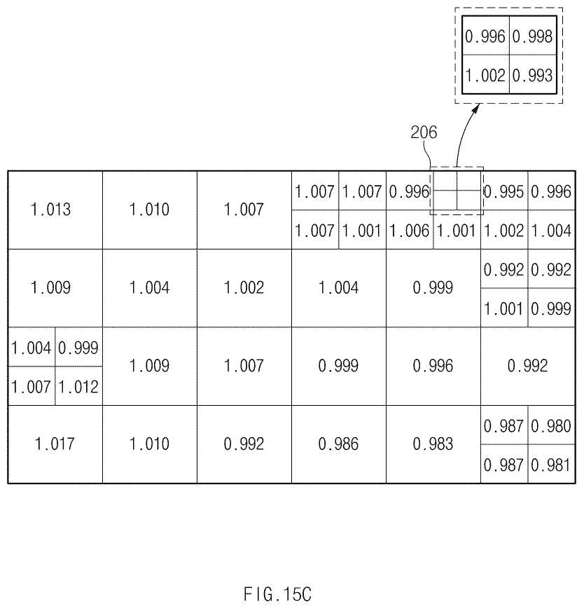

FIG. 15A is a diagram illustrating a method of determining the median value of the correction grade of FIG. 12 according to the third embodiment.

Referring to FIGS. 1, 14, and 15A, there are a total of 45 division areas included in the correction target areas, and the correction grade corresponding to the median value may correspond to ‘Level 4’. The number ‘4’ circled in FIG. 15A may mean the correction grade corresponding to the 23rd median value.

FIG. 15B is a diagram illustrating the average pixel value of the correction target areas having the median value of the correction grade determined in FIG. 15A according to the third embodiment. Referring to FIGS. 1, 5, 7 to 9, 12, 14, 15B, and 15C, the method of calculating the correction parameter according to the third embodiment may be a method of using the average of all pixel values of division areas each having ‘Level 4’ corresponding to a median value of the correction grade in the correction target areas.

For example, referring to FIG. 15B, the number of the division areas each having ‘Level 4’ from among the division areas included in the correction target areas may be 8. That is, the division areas of Level 4 may include the eleventh area 111, the sixteenth area 116, the 28th area 204, the 29th area 205, the 32nd area 208, the 39th area 215, the 40th area 216, and the 42nd area 218. When calculating the average of all pixels included in the eight areas, 64.66 may be calculated as shown in FIG. 15B.

FIG. 15C is a diagram illustrating the results of calculating correction parameters for each correction target area of the dark image of FIG. 9 according to the third embodiment.

The correction parameter may be set to a value divided by the overall average of pixels included in the division areas (each having the median value of the correction grade) by an average of pixel values of pixels of each of the division areas included in the correction target areas. The correction parameter may be, for example, a gain value to be used when the imaging device 1000 performs image correction in an image signal processing stage.

For example, in the case of the first area 101, the average pixel value may be 63.8 according to FIG. 5. Therefore, the correction parameter value of the first area 101 may be 1.013 obtained by dividing 64.66 by 63.8. For example, in the case of the second area 102, the average pixel value may be 64.0 according to FIG. 5. Therefore, the correction parameter value of the second area 102 may be 1.010 obtained by dividing 64.66 by 64.0. For example, in the case of the third area 103, the average pixel value may be 64.2 according to FIG. 5. Accordingly, the correction parameter value of the second area 102 may be 1.007 obtained by dividing 64.66 by 64.2.

The correction parameter setting circuit 2400 may perform the same calculation process in the seventh to eleventh areas (107˜111), the 14th to 23rd areas (114˜123), the 25th to 29th areas (201˜205), and the 31st to 52nd areas (207˜224, 301˜304), and the results of performing the calculation process can be seen in FIG. 15C.

When correction parameter values are calculated according to the third embodiment, the correction grade located at the median value is used, so that the third embodiment can obtain results that are evenly corrected overall either in a first case where distribution of pixel values of the respective pixels having created the dark image is extremely biased or in a second case where there are many correction target areas having a very low standard deviation (e.g., 0.01 or less).

The methods for calculating correction parameter values according to the first to third embodiments described above can provide a method for calculating a correction parameter capable of correcting the shading phenomenon caused by a voltage drop phenomenon that may occur according to where each pixel is located in the pixel array. The first to third embodiments are merely examples for explaining the technical idea of the disclosed technology, and the scope of the technical idea of the disclosed technology is not limited thereto. FIGS. 4 to 15C are only for explaining numerically specific embodiments to explain the flowcharts of FIGS. 2 and 3, and are not intended to limit the technical idea of the disclosed technology to the exemplary numerical values described above.

As is apparent from the above description, the dark shading correction method and the device for implementing the same based on some implementations of the disclosed technology may perform individual dark shading correction for each portion of an image, and may provide images with improved quality.

The embodiments of the disclosed technology may provide a variety of effects capable of being directly or indirectly recognized through the above-mentioned patent document.

Those skilled in the art will appreciate that the disclosed technology may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. A dark shading correction method for processing images from an image sensing device, comprising:
dividing a dark image captured by the image sensing device with an array of image sensing pixels under a no-light condition into a plurality of first areas;
calculating a standard deviation for each of the plurality of first areas by using pixel values of at least one pixel included in each of the plurality of first areas;
dividing a first area having a standard deviation greater than or equal to a preset reference standard deviation into a plurality of second areas; and
calculating a correction parameter for each of correction target areas including a first area having a standard deviation less than the reference standard deviation and at least one of the plurality of second areas.

2. The dark shading correction method according to claim 1, wherein:
each of the plurality of second areas having an (m×n) matrix structure,
wherein ‘m’ and ‘n’ are natural numbers and at least one of ‘m’ or ‘n’ is an integer equal to or greater than 2.

3. The dark shading correction method according to claim 1, further comprising:
calculating a standard deviation for each of the plurality of second areas by using pixel values of at least one pixel included in each of the plurality of second areas; and
dividing a second area having a standard deviation greater than or equal to the reference standard deviation into a plurality of third areas.

4. The dark shading correction method according to claim 3, further comprising:
calculating correction parameters for each of the plurality of third areas.

5. The dark shading correction method according to claim 3, wherein:
each of the plurality of third areas having an (m×n) matrix structure,
wherein ‘m’ and ‘n’ are natural numbers, at least one of ‘m’ or ‘n’ is an integer equal to or greater than 2.

6. The dark shading correction method according to claim 1, wherein:
the correction parameter is obtained by dividing a preset reference pixel value by an average of pixel values of pixels of each of the correction target areas.

7. The dark shading correction method according to claim 1, wherein:
the correction parameter is obtained by dividing an average of pixel values of pixels of at least one first area located at a center of the dark image by an average of pixel values of pixels of each of the correction target areas.

8. The dark shading correction method according to claim 7, further comprising:
assigning a correction grade to each of the correction target areas based on an average of pixel values of pixels of each of the correction target areas.

9. The dark shading correction method according to claim 8, wherein:
the correction parameter is obtained by dividing an average of all pixel values of pixels included in the correction target areas having a median value of the correction grade by the average of pixel values of pixels of each of the correction target areas.

10. An imaging device comprising:
an image sensing device including an array of pixels for converting incident light into pixel signals representing an image captured in the incident light, the captured image including a first correction target area having a first number of pixels, and a second correction target area having a second number of pixels, the second number being smaller than the first number; and
a memory device storing a first correction parameter for correcting dark shading in the first correction target area due to noise present in the first number of pixels of the image sensing device without incident light thereto, and a second correction parameter for correcting dark shading in the second correction target area due to noise present in the second number of pixels of the image sensing device without incident light thereto.

11. The imaging device according to claim 10, wherein the image sensing device further includes
a third correction target area having a third number of the pixels, the third number being smaller than the second number,
wherein the memory device further stores a third correction parameter for correcting dark shading in the third correction target area due to noise present in the third number of pixels of the image sensing device without incident light thereto.

12. The imaging device according to claim 10, wherein:
the first correction target area corresponds to one of a plurality of first division areas obtained by equally dividing the image.

13. The imaging device according to claim 12, wherein:
the second correction target area corresponds to one of a plurality of second division areas obtained by equally dividing one of the plurality of first division areas.

14. The imaging device according to claim 13, wherein:
each of the plurality of second division areas is arranged in areas of an (m×n) matrix structure,
wherein ‘m’ and ‘n’ are natural numbers, at least one of ‘m’ or ‘n’ is an integer equal to or greater than 2.

15. The imaging device according to claim 10, wherein:
the first correction parameter and the second correction parameter have different values from each other.

16. A dark shading correction system for processing images captured by an image sensing device, comprising:
an image sensing device configured to generate at least one image under a no-light condition without incident light at the image sensing device;
a dark image generator configured to generate a dark image based on the at least one image;
a dark image division circuit configured to divide the dark image into a plurality of first areas, and to divide a first area having a standard deviation greater than or equal to a preset reference standard deviation into a plurality of second areas;
an image division determiner configured to calculate a standard deviation for each of the plurality of first areas by using pixel values of at least one pixel included in the plurality of first areas, and to calculate a standard deviation for each of the plurality of second areas by using pixel values of at least one pixel included in the plurality of second areas;
a correction parameter setting circuit configured to calculate a correction parameter for each of correction target areas including first areas having a standard deviation less than the reference standard deviation and the plurality of second areas; and
a memory device configured to store the correction target areas and correction parameters for each of the correction target areas.

17. The dark shading correction system of claim 16, wherein the dark image is divided into the plurality of first areas arranged in a (m×n) matrix structure, wherein at least one of ‘m’ or ‘n’ is an integer equal to or greater than 2.

18. The dark shading correction system of claim 16, wherein the dark image division circuit is further configured to divide a second area having a standard deviation greater than or equal to the preset reference standard deviation into a plurality of third areas.
